(19) United States
(12) Patent Application Publication
(10) Pub. No.: US 2024/0427975 A1
(43) Pub. Date: Dec. 26, 2024

(54) METHODS, SYSTEMS, APPARATUS, AND ARTICLES OF MANUFACTURE TO VALIDATE TIMING CONSTRAINTS FOR AN INTEGRATED CIRCUIT

(71) Applicant: Intel Corporation, Santa Clara, CA (US)

(72) Inventors: Rakesh Kandula, Bangalore (IN); Srinivasa Ramakrishna STG, Bangalore (IN)

(21) Appl. No.: 18/340,662

(22) Filed: Jun. 23, 2023

(51) Int. Cl. G06F 30/3315; G06F 1/04

(52) U.S. Cl. CPC G06F 30/3315; G06F 1/04; G06F 2111/04; G06F 2119/12

(57) ABSTRACT

Methods, systems, apparatus, and articles of manufacture to validate timing constraints for an integrated circuit are disclosed. An example apparatus disclosed herein includes programmable circuitry to obtain an assumption property associated with a system on a chip (SoC) architecture, obtain a timing assertion associated with the SoC architecture, determine, using a formal property verification (FPV) tool, valid functional vectors and counter examples for the SoC architecture based on the assumption property and the timing assertion, and determine whether to accept a timing constraint based on at least one of the valid functional vectors or the counter examples, the timing constraint corresponding to the timing assertion.

### FIELD OF THE DISCLOSURE

This disclosure relates generally to integrated circuits and, more particularly, to methods, systems, apparatus, and articles of manufacture to validate timing constraints for an integrated circuit.

### BACKGROUND

As integrated circuitry becomes increasingly complex, designers are incentivized to automate designing of semiconductor packages from abstractions of electronic designs. In recent years, formal property verification (FPV) tools have automated generation and/or validation of relatively complex semiconductor packages and/or corresponding register-transfer level (RTL) designs.

### BRIEF DESCRIPTION OF THE DRAWINGS

FIG. 1 illustrates an integrated circuit (IC) package that may be produced based on an example formal verification procedure implemented by the example validation control circuitry.

FIG. 2 is a block diagram of example validation control circuitry in accordance with teachings of this disclosure.

FIG. 3 illustrates an example SoC signal diagram for which the example validation control circuitry 200 of FIG. 2 can be used to validate and/or verify one or more example timing constraints.

FIG. 4 illustrates example signals observed and/or modelled by the example validation control circuitry for the example diagram of FIG. 3.

FIG. 5 is a flowchart representative of example machine readable instructions and/or example operations that may be executed, instantiated, and/or performed by example programmable circuitry to implement the validation control circuitry 200 of FIG. 2 to verify example timing constraints.

FIG. 6 is a flowchart representative of example machine readable instructions and/or example operations that may be executed, instantiated, and/or performed by example programmable circuitry to implement the validation control circuitry 200 of FIG. 2 to verify example timing constraints based on X propagation.

FIG. 7 is a block diagram of an example processing platform including programmable circuitry structured to execute, instantiate, and/or perform the example machine readable instructions and/or perform the example operations of FIGS. 5 and/or 6 to implement the validation control circuitry 200 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

A system on a chip (SoC) is an integrated circuit (IC) that implements multiple components of an electronic device on a single chip. For instance, the components of a SoC can include one or more of a central processing unit (CPU), a graphics processing unit (GPU), memory, input and output interfaces, a timer, a signal processor, a signal converter, etc. In some instances, ones of the components are electrically and/or communicatively coupled together to enable sending of signals and/or data between the ones of the components and, thus, enable execution of one or more functions by the SoC. In some instances, a SoC architecture defines hardware specifications (e.g., locations of the components and/or the connections therebetween, types of the components and/or the connections, etc.) as well as software for controlling one(s) of the components of the SoC. Typically, the SoC architecture is selected based on a desired performance, efficiency, power consumption, speed, size, and/or bandwidth for one(s) of the components and/or the connections.

Due to the complexity of integrating a large number (e.g., hundreds, thousands, etc.) of components onto a single chip, one or more computer programs are commonly used to select and/or design the SoC architecture for a given SoC. For instance, a designer (e.g., a SoC designer) can begin by modelling, in a computer program, hardware components and/or associated software of the SoC at an abstract level. In particular, the SoC architecture can be modelled at the register-transfer level (RTL), where an RTL design represents the flow of signals between components and/or operations performed on the signals. Stated differently, RTL designs are abstract specifications of desired behavior of circuitry. Typically, RTL designs are created using a hardware description language (HDL), such as Verilog, system Verilog, very high-speed integrated circuitry hardware description language (VHSIC or VHDL), etc. Alternatively, designers may create a relatively higher-level abstraction of an RTL design using a programming language, such as C, C++, C#, etc. In some instances, designers may use a converter, a compiler, and/or a synthesis tool to obtain the RTL design from the relatively higher-level abstraction.

After generation, the RTL design is validated and/or verified. For instance, static methods (e.g., static timing analysis (STA)) and/or dynamic methods (e.g., gate-level simulations, X injection) can be used to validate timing performance (e.g., timing constraints) of the design. In some instances, the timing constraints define expected timing performance for one or more elements of the RTL design. For instance, the timing constraints can include one or more multi cycle paths (e.g., paths that are allowed more than one clock cycle to complete), false paths (e.g., paths that need not be timed), cross clock global asynchronous paths, clock characteristics, timing exceptions, etc.

For some static methods, the RTL design is divided into timing paths, and a signal propagation delay along each of the timing paths is determined. To verify the RTL design, a static methods tool (e.g., static timing analysis) checks for correctness of one or more of the timing constraints defined for the timing paths. For instance, the static methods tool determines all possible test cases (e.g., test vectors) for stressing the timing paths from corresponding start points to end points, then determines whether the timing constraints are satisfied for respective ones of the timing paths. Static methods necessitate manual intervention by an SoC designer to waive one(s) of the test cases that are not functionally correct (e.g., that result in false negatives and/or true negatives). Such manual intervention may be time consuming and/or prone to error for SoC designs having a large number (e.g., thousands, millions) of possible test cases.

Alternatively, dynamic verification methods can be used to verify the RTL design. For instance, timing-based gate-level simulations (e.g., simulations for which gate delays are known) can test functional performance in addition to timing performance of the SoC design. However, such gate-level simulations typically require several days or weeks of run time to verify a single SoC design. Another method of dynamic verification involves insertion of X injection instrumentation code into the RTL design code. The X injection instrumentation code causes insertion of X values (e.g., unknown logic values) at one or more locations of the RTL design during simulation of the RTL design. In such cases, propagation of the X values can be evaluated to determine whether timing constraints along one or more timing paths of the RTL design are satisfied. While such an X injection approach can reduce the run time required for verification, an appropriate test case (e.g., an input vector, a test vector) must be selected to stress particular timing paths to which the timing constraints are applied. Selection of the test case is performed manually, and error in selecting the appropriate test case may result in inadequate testing of the timing paths and/or the associated timing constraints.

Examples disclosed herein utilize formal verification methodologies (e.g., formal methods, formal property verification (FPV) methods) to verify timing constraints for an example SoC design. In examples disclosed herein, an example FPV tool (e.g., a formal tool) is a software application that utilizes mathematical proofs to determine whether an SoC design satisfies one or more example specifications and/or one or more example constraints associated with the SoC design. For example, the specifications and/or constraints are input to the FPV tool as example properties, where the properties can include one or more example assumptions (e.g., architectural assumptions, assumption properties) and/or one or more example assertions. In some examples, the assertions correspond to properties that are targeted for formal verification, and the assumptions are properties used to limit and/or define a formal analysis space (e.g., to define initial states, to identify states that the FPV tool should not check, etc.). In examples disclosed herein, example assumptions, example timing constraints, and/or an example RTL design for the SoC design are provided (e.g., ported, input) to the example FPV tool. In some examples, the FPV tool automatically converts the timing constraints into timing assertions, and/or a user can manually convert the timing constraints into timing assertions prior to input into the FPV tool. In examples disclosed herein, based on the assumptions, the timing constraints, and/or the RTL design, the FPV tool outputs one or more example functional vectors (e.g., valid functional vectors) that can be used to prove the timing assertions input to the FPV tool. Additionally, the FPV tool can output counter examples that attempt to disprove one or more of the timing assertions. In particular, counter examples are valid functional vectors among permutations of possible inputs to the RTL design that result in failure of one or more of the timing assertions.

In some examples, example validation control circuitry disclosed herein uses X propagation to determine the functional vectors and/or the counter examples. For example, the validation control circuitry identifies, based on the timing assertions, one or more locations (e.g., one or more timing paths) of the RTL design at which example X values (e.g., unknown logic values) are to be provided (e.g., injected) to the RTL design during simulation. In some such examples, the validation control circuitry determines a duration (e.g., in clock cycles) for which the X values are to be provided to the RTL design. In some examples, the validation control circuitry simulates one or more example input vectors (e.g., test cases) on the RTL design, and evaluates the propagation of the X values to determine whether the timing assertions are satisfied and, thus, whether the input vectors correspond to ones of the valid functional vectors and/or the counter examples. In examples disclosed herein, the validation control circuitry validates and/or verifies one(s) of the timing constraints based on whether the counter examples fail and/or disprove one(s) of the timing assertions corresponding to the one(s) of the timing constraints. For example, the validation control circuitry accepts first one(s) of the timing constraints when the associated timing assertions are satisfied, and the validation control circuitry rejects second one(s) of the timing constraints when the associated timing assertions fail responsive to the counter examples. In some examples, the validation control circuitry modifies rejected one(s) of the timing constraints based on the counter examples.

Advantageously, examples disclosed herein enable timing constraints to be provided as example assertions (e.g., assertion properties, timing assertions) to an example FPV tool. While some known static and/or dynamic verification methods necessitate manual intervention to waive test cases (e.g., input vectors) that do not satisfy architectural intent for a SoC architecture, examples disclosed herein automatically select valid functional vectors (e.g., including counter examples) based on the assertions and example architectural assumptions (e.g., assumption properties) provided to the FPV tool. Accordingly, examples disclosed herein reduce error in selection of appropriate test cases and/or reduce a number of the test cases to be tested and/or simulated for an example RTL design.

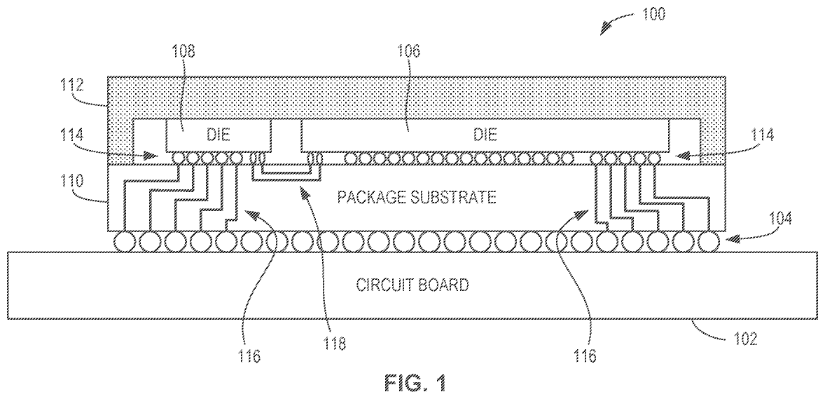

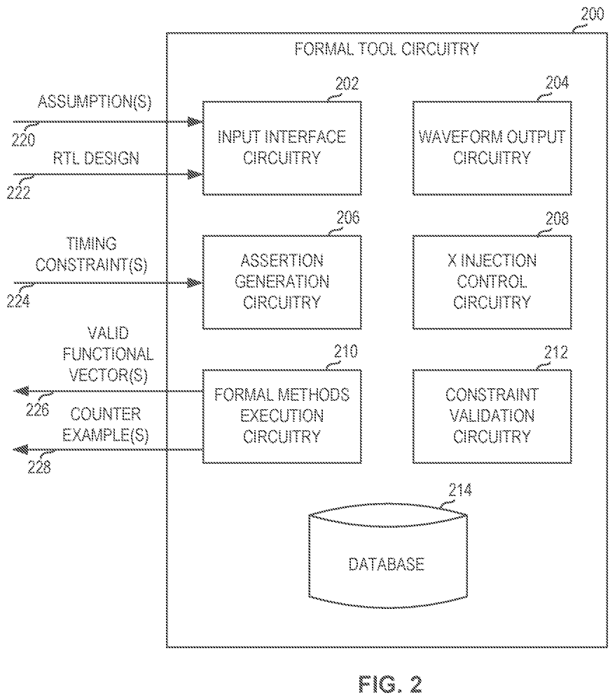

FIG. 1 illustrates an integrated circuit (IC) package 100 that may be produced based on an example formal verification procedure implemented by the example validation control circuitry 200 of FIG. 2. In the example of FIG. 1, the IC package 100 is electrically coupled to a printed circuit board (PCB) 102 by first electrical connections 104. The first electrical connections 104 may include pins, pads, bumps, and/or balls to enable the electrical coupling of the IC package 100 to the circuit board 102. In this example, the IC package 100 includes two semiconductor (e.g., silicon) dies 106, 108 that are mounted to a package substrate 110 and enclosed by a package lid or mold compound 112. While the example IC package 100 of FIG. 1 includes two dies 106, 108, in other examples, the IC package 100 may have fewer or more than two dies.

As shown in the illustrated example, each of the dies 106, 108 is electrically and mechanically coupled to the package substrate 110 via second electrical connections 114. The second electrical connections 114 may include pins, pads, balls, and/or bumps. The second electrical connections 114 between the dies 106, 108 and the package substrate 110 are sometimes referred to as first level interconnects. By contrast, the first electrical connections 104 between the IC package 100 and the circuit board 102 are sometimes referred to as second level interconnects. In some examples, one or both of the dies 106, 108 may be stacked on top of one or more other dies and/or an interposer. In such examples, the dies 106, 108 are coupled to the underlying die and/or interposer through a first set of first level interconnects and the underlying die and/or interposer may be connected to the package substrate 110 via a separate set of first level interconnects associated with the underlying die and/or interposer.

As shown in the illustrated example, the package substrate 110 includes first electrical traces and/or circuit lines (e.g., routing) 116 that electrically connect the first electrical connections 104 to the second electrical connections 114, thereby enabling the electrical coupling of the first and/or second dies 106, 108 with the circuit board 102. Further, in some examples, the package substrate 110 includes second electrical traces and/or circuit lines (e.g., routing) 118 that electrically connect different ones of the first electrical connections 104 associated with the first and second dies 106, 108, thereby enabling the electrical coupling of the first and second dies 106, 108.

In some examples, locations and/or timing characteristics for one or more components (e.g., the first electrical connections 104, the second electrical connections 114, the first electrical traces and/or circuit lines 116, and/or the second electrical traces and/or circuit lines 118, etc.) of the IC package 100 are selected prior to fabrication of the IC package 100. For example, prior to fabrication, an example RTL design (e.g., RTL code) can be generated based on system specifications and/or architectural intent for the IC package 100. In examples disclosed herein, the validation control circuitry 200 verifies functional behavior and/or timing constraints of the RTL design prior to implementation of the RTL design in the IC package 100.

FIG. 2 is a block diagram of example validation control circuitry 200 to validate and/or verify timing constraints of an example SoC design in accordance with teachings of this disclosure. The validation control circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the validation control circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the example validation control circuitry 200 includes example input interface circuitry 202, example waveform output circuitry 204, example assertion generation circuitry 206, example X injection control circuitry 208, example formal methods execution circuitry 210, example constraint validation circuitry 212, and an example database 214.

The example database 214 stores data utilized and/or obtained by the validation control circuitry 200. The example database 214 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example database 214 may be in any data format such as, for example, binary data, comma delimited data, tab delimited data, structured query language (SQL) structures, etc. While, in the illustrated example, the example database 214 is illustrated as a single device, the example database 214 and/or any other data storage devices described herein may be implemented by any number and/or type(s) of memories.

The example input interface circuitry 202 of FIG. 2 obtains and/or accesses example input data to be used for validating an example SoC design. For example, the input interface circuitry 202 obtains one or more example assumptions (e.g., architectural assumptions, assumption properties) 220 associated with the SoC design. In some examples, the assumptions 220 are properties that reduce and/or define a design space (e.g., a formal analysis space) for the SoC design. For example, the assumptions 220 limit and/or constrain the design space by defining initial states of one or more elements of the SoC, identifying one(s) of the states that need not be checked, etc. In one example, the assumptions 220 can indicate that, for a given first in first out (FIFO) element of the SoC, data cannot be written to the FIFO when the FIFO is full. Conversely, in some examples, the assumptions 220 can indicate that data cannot be read from the FIFO when the FIFO is empty. Additionally or alternatively, one or more different assumptions 220 may be used. In some examples, the assumptions 220 are written to the FPV tool using a computer programming language (e.g., Property Specification Language (PSL), SystemVerilog Assertions (SVA), etc.) used for specifying properties of an electronic system. For example, ones of the assumptions 220 associated with a given FIFO can be written as shown below.

assume property (@ (posedge Clock) fifo_full |−> ! write_valid;
assume property (@ (posedge Clock) fifo_empty |−> ! read_valid;

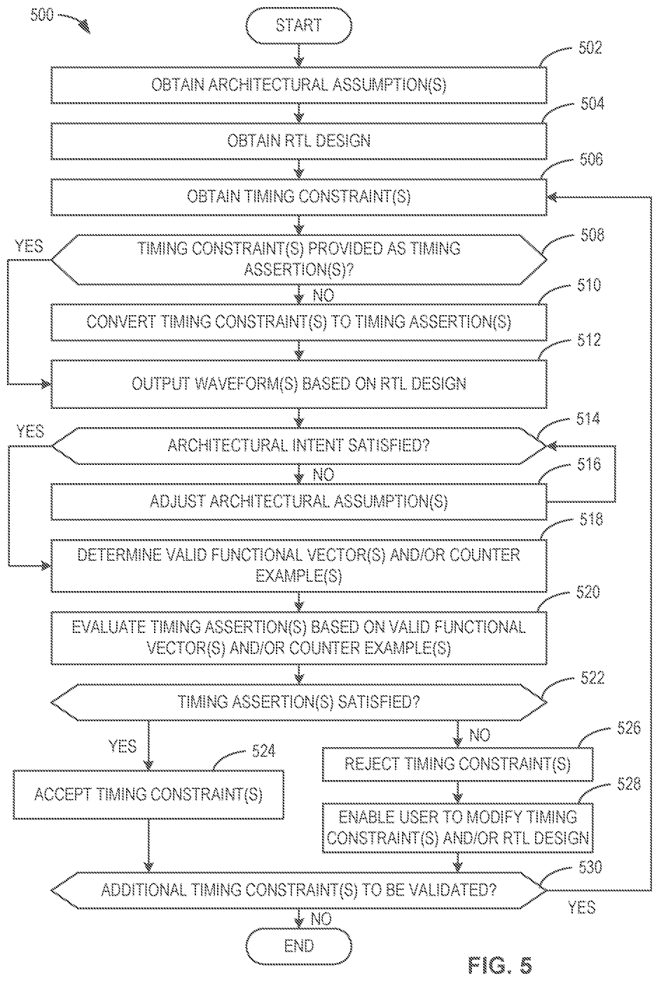

In the illustrated example of FIG. 2, the input interface circuitry 202 obtains and/or accesses an example register-transfer level (RTL) design 222 associated with the example SoC. For example, the RTL design 222 represents flow of signals between hardware registers of the SoC and/or one or more logical operations performed on the signals. In some examples, the RTL design 222 can be expressed using a hardware description language (HDL), such as VHDL or Verilog. In some examples, the input interface circuitry 202 provides code representing the assumptions 220 and/or the RTL design 222 to the example database 214 for storage therein. In some examples, the input interface circuitry 202 is instantiated by programmable circuitry executing input interface circuitry instructions and/or configured to perform operations such as those represented by the flowchart(s) of FIGS. 5 and/or 6.

The example assertion generation circuitry 206 of FIG. 2 generates and/or obtains one or more example timing assertions to be validated and/or verified by the validation control circuitry 200. In some examples, the assertion generation circuitry 206 obtains the timing assertions based on a designer inputting (e.g., coding) the timing assertions directly into the FPV tool. In some examples, the assertion generation circuitry 206 generates the timing assertions based on one or more example timing constraints 224 provided as input to the FPV tool. In some examples, the timing constraints 224 represent expected timing performance for one or more elements of the SoC design. For example, the timing constraints 224 can describe clock characteristics, timing exceptions (e.g., a multi cycle path, a false path, a maximum delay path, a minimum delay path, a reconverge cross clock path, etc.), signal transition times, etc.

In some examples, the assertion generation circuitry 206 automatically generates the example assertions for corresponding ones of the timing constraints 224. For example, when the timing constraints 224 define a multi cycle path of N clock cycles between a start point A and an end point B of the SoC design, the corresponding timing assertion indicates that data (e.g., represented by a waveform) sampled at end point B should not change within N clock cycles. Stated differently, if the data from start point A to end point B changes from a first value (e.g., 0) to a second value (e.g., 1), the data at end point B will show the first value for N clock cycles and will show the second value at a clock cycle of N+1. In some examples, one or more different timing constraints 224 and/or timing assertions can be used instead. In some examples, the assertion generation circuitry 206 provides code representing the timing constraints 224 and/or the timing assertions to the example database 214 for storage therein. In some examples, the assertion generation circuitry 206 is instantiated by programmable circuitry executing assertion generation circuitry instructions and/or configured to perform operations such as those represented by the flowchart(s) of FIGS. 5 and/or 6.

The example waveform output circuitry 204 of FIG. 2 outputs and/or displays example signal information (e.g., waveforms) based on the RTL design 222 and/or the assumptions 220. For example, the signal information represents signal responses seen at one or more locations of the RTL design 222 in response to simulated input of signals to the RTL design 222. In some examples, the signal information output by the waveform output circuitry 204 allows a designer to verify whether one or more of the assumptions 220 have been correctly coded and/or input to the FPV tool. For example, the designer can inspect the signal information to determine whether the signal information abides by the intended architectural properties of the RTL design 222. In some examples, when the signal information indicates that one or more of the assumptions 220 are being violated (e.g., data is being written to a FIFO when the FIFO is full, data is being read from a FIFO when the FIFO is empty, etc.), the designer can identify one(s) of the assumptions 220 being violated and can troubleshoot and/or correct code corresponding to the one(s) of the assumptions 220. In some examples, the waveform output circuitry 204 is instantiated by programmable circuitry executing waveform output circuitry instructions and/or configured to perform operations such as those represented by the flowchart(s) of FIGS. 5 and/or 6.

The example X injection control circuitry 208 of FIG. 2 generates X injection code (e.g., X injection instrumentation code) to enable x-propagation testing of the timing constraints 224. In some examples, HDLs such as Verilog use a symbol “X” to represent unknown logic values. In some examples, x-propagation occurs when one or more X values feed into downstream logic of the RTL design 222, resulting in additional unknown values. In some examples, X values can be intentionally injected at one or more locations of the RTL design 222, and the propagation of the X values through the RTL design 222 can be monitored to identify bugs in the RTL design 222 and/or verify one(s) of the timing constraints 224.

In some examples, a designer manually selects the one or more locations for injection of the X values based on the one(s) of the timing constraints 224 to be tested and/or verified. For example, when a given one of the timing constraints 224 is defined along an example timing path from start point A to end point B, the designer typically selects a location at the start point A or the end point B for insertion of the X injection code. In such examples, when the one of the timing constraints 224 defines a path of N cycles between start point A and end point B, the designer inserts code to inject X for N−1 cycles. However, incorrect selection of the location for X injection may result in the timing path not being properly stressed and/or tested during simulation of the RTL design 222.

In the illustrated example of FIG. 2, the X injection control circuitry 208 automatically selects (e.g., without intervention by the designer) location(s) for insertion of the X injection code into the RTL design 222. For example, the X injection control circuitry 208 determines, based on the timing constraints 224 and/or the corresponding timing assertions obtained by the assertion generation circuitry 206, the location(s) at which X values are to be injected to enable testing and/or verification of the timing constraints 224 and/or the timing assertions. For example, when the timing constraints 224 define a multi cycle path of N clock cycles between a start point A and an end point B in the RTL design 222, the X injection control circuitry 208 automatically determines that X is to be injected for N−1 cycles along the timing path between the start point A and the end point B. In such examples, the X injection control circuitry 208 generates and/or provides the X injection code to the FPV tool. In some examples, the X injection control circuitry 208 is instantiated by programmable circuitry executing X injection control circuitry instructions and/or configured to perform operations such as those represented by the flowchart(s) of FIGS. 5 and/or 6.

The example formal methods execution circuitry 210 of FIG. 2 implements an example FPV tool to determine one or more example valid functional vectors 226 including one or more example counter examples 228 based on the RTL design 222, the assumptions 220, and/or the timing constraints 224. For example, the formal methods execution circuitry 210 determines possible test cases (e.g., vectors) to stress (e.g., test) one or more timing paths of interest in the RTL design 222. In some examples, the vectors represent multiple (e.g., all) possible permutations of inputs to the RTL design 222. For example, for the RTL design 222 having N inputs, where each input corresponds to a binary value (e.g., 0 or 1), the formal methods execution circuitry 210 can determine 2^{N} different vectors (e.g., test vectors, input vectors) for stressing the timing path(s) of interest. In the example of FIG. 2, the formal methods execution circuitry 210 excludes and/or omits one(s) of the possible vectors that violate (e.g., do not satisfy) one or more of the assumptions 220. For example, when the assumptions 220 indicate that data cannot be written to a FIFO when the FIFO is full, the formal methods execution circuitry 210 excludes one(s) of the vectors that attempt to write data to the FIFO when the FIFO is full. Conversely, when the assumptions 220 indicate that data cannot be read from the FIFO when the FIFO is empty, the formal methods execution circuitry 210 excludes one(s) of the vectors that attempt to read data from the FIFO when the FIFO is empty. In some examples, the formal methods execution circuitry 210 determines and/or outputs only a subset of the possible input vectors that satisfy the assumptions 220 and, thus, does not determine and/or output ones of the possible input vectors that do not satisfy the assumptions 220.

In some examples, the formal methods execution circuitry 210 determines and/or outputs the valid functional vectors 226 corresponding to first one(s) of the vectors that satisfy the assumptions 220 and the timing assertions corresponding to the timing constraints 224. In some examples, the formal methods execution circuitry 210 determines the valid functional vectors 226 based on mathematical proofs that are bounded based on the assumptions 220 and intended to prove the timing assertions. In some examples, the formal methods execution circuitry 210 also determines and/or outputs the counter examples 228 corresponding to second one(s) of the vectors that satisfy the assumptions 220 (e.g., are functionally valid), but fail and/or disprove one or more of the timing assertions. Stated differently, in some examples, the counter examples 228 correspond to one(s) of the valid functional vectors 226 that fail the timing assertions. In some examples, the formal methods execution circuitry 210 provides the valid functional vectors 226 and/or the counter examples to the database 214 for storage therein. In some examples, the formal methods execution circuitry 210 is instantiated by programmable circuitry executing formal methods execution circuitry instructions and/or configured to perform operations such as those represented by the flowchart(s) of FIGS. 5 and/or 6.

The example constraint validation circuitry 212 determines whether to accept and/or reject one(s) of the timing constraints 224. For example, the constraint validation circuitry 212 evaluates one(s) of the valid functional vectors 226 and/or the counter examples 228 to determine whether to accept and/or reject one(s) of the timing constraints 224. In some examples, when one(s) of the vectors corresponding to the counter examples 228 are provided as input to the RTL design 222, the constraint validation circuitry 212 determines whether corresponding one(s) of the timing assertions fail (e.g., are not satisfied) in response to the input.

In some examples, the constraint validation circuitry 212 accepts and/or validates first one(s) of the timing constraints 224 associated with first one(s) of the timing assertions that do not fail (e.g., are satisfied) in response to the counter examples 228. Conversely, the constraint validation circuitry 212 rejects second one(s) of the timing constraints 224 associated with second one(s) of the timing assertions that fail (e.g., are not satisfied) in response to one or more of the counter examples 228. Stated differently, the constraint validation circuitry 212 accepts the first one(s) of the timing constraints 224 when there are no counter examples 228 that fail the corresponding timing assertions. Conversely, the constraint validation circuitry 212 rejects the second one(s) of the timing constraints 224 when there is at least one of the counter examples 228 that fails the corresponding timing assertions. In some examples, the constraint validation circuitry 212 accepts and/or rejects one(s) of the timing constraints 224 based on user input. For example, the designer can manually inspect the counter examples that fail corresponding one(s) of the timing assertions and/or the timing constraints 224, and the designer can provide user input to the FPV tool to indicate whether to accept and/or reject the one(s) of the timing constraints 224.

In some examples, in response to the constraint validation circuitry 212 rejecting the second one(s) of the timing constraints 224, the constraint validation circuitry 212 determines whether one or more of the timing constraints 224 are to be modified. For example, the constraint validation circuitry 212 outputs an indication that the second one(s) of the timing constraints 224 should be modified (e.g., a multi cycle path of 3 cycles should be changed to 2 cycles, etc.) to satisfy the one(s) of the counter examples 228. In some examples, in response to rejecting the one(s) of the timing constraints 224, the constraint validation circuitry 212 outputs an indication that an architectural design of the SoC can be modified to satisfy the timing constraints 224. For example, the indication can indicate one(s) of the timing constraints 224 that were rejected and/or can include a recommendation for modifications to the one(s) of the timing constraints 224. In some examples, the designer can modify one(s) of the timing constraints 224 and/or the RTL design 222 based on the recommendation. In some examples, the constraint validation circuitry 212 is instantiated by programmable circuitry executing constraint validation circuitry instructions and/or configured to perform operations such as those represented by the flowchart(s) of FIGS. 5 and/or 6.

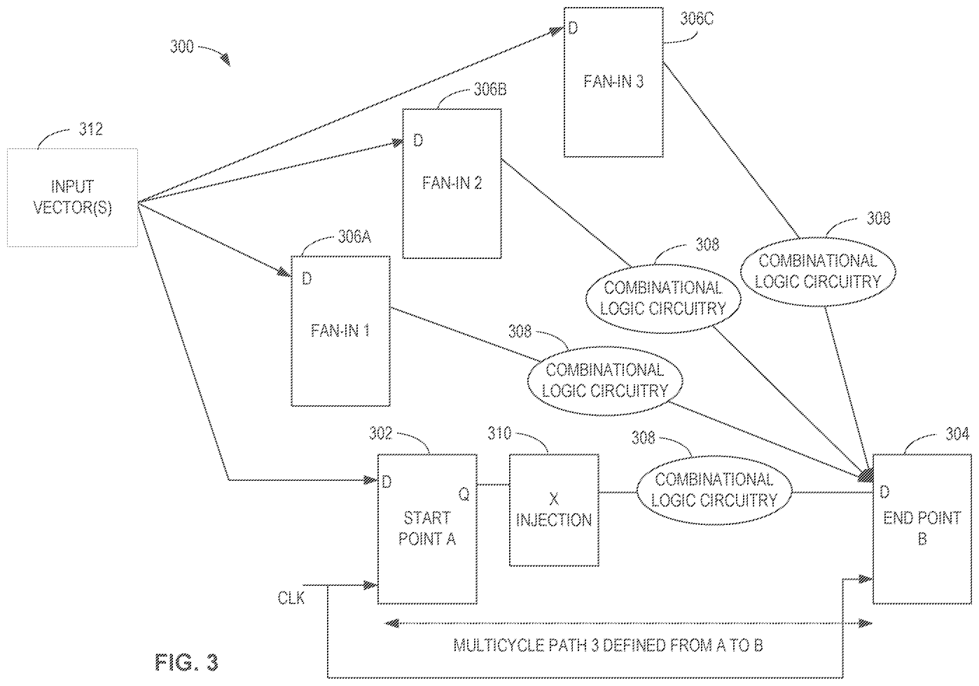

FIG. 3 illustrates an example diagram (e.g., a signal diagram) 300 representing an example SoC, where the example validation control circuitry 200 of FIG. 2 can be used to validate and/or verify one or more example timing constraints (e.g., the timing constraints 224 of FIG. 2) of the SoC design. In the illustrated example of FIG. 3, the diagram 300 includes an example start point A 302 and an example end point B 304, where an example multicycle path of 3 cycles (e.g., clock cycles) is defined from the start point A 302 to the end point B 304. In the example of FIG. 3, the diagram 300 includes a first example fan-in 306A, a second example fan-in 306B, and a third example fan-in 306C, where the fan-ins 306 and the start point A 302 are coupled to respective example combinational logic circuitry 308. In the illustrated example, the combinational logic circuitry 308 is further coupled to the end point B 304.

In the illustrated example of FIG. 3, the example timing constraint (e.g., defining a multicycle path of 3 cycles between the start point A 302 and the end point B 304) is provided to the validation control circuitry 200 for validation and/or verification. In this example, the validation control circuitry 200 uses X propagation to validate and/or verify the timing constraint. In some examples, X propagation involves insertion of X values (e.g., unknown logic values) at one or more first locations of the diagram 300, and sampling of signals at one or more second locations to monitor the propagation of the X values. In some examples, based on the presence or absence of the X values at the second location(s), the validation control circuitry 200 can determine whether the timing constraints for one or more timing paths are satisfied and/or correctly defined.

In the illustrated example of FIG. 3, based on the timing constraint provided, the validation control circuitry 200 determines (e.g., automatically determines) an example location for X injection 310. For example, the validation control circuitry 200 selects the location and/or a number of cycles for which X can be injected to attempt to fail and/or disprove the timing constraint. In the example of FIG. 3, for a multicycle path of 3 cycles defined between the start point A 302 and the end point B 304, data (e.g., signal values) observed at the end point B 304 should not change within 3 cycles. Accordingly, to verify the multicycle path of 3 cycles, the validation control circuitry 200 determines that X is to be injected along the timing path between the start point A 302 and the end point B 304 for 2 cycles.

In the example of FIG. 3, the validation control circuitry 200 of FIG. 2 provides one or more example input vectors 312 as input to the start point A 302 and the fan-ins 306. In some examples, where the inputs to corresponding ones of the start point A 302 and the fan-ins 306 are binary values (e.g., 0 or 1), the validation control circuitry 200 determines the input vectors 312 by determining multiple (e.g., all) permutations of the inputs to the start point A 302 and the fan-ins 306. In the illustrated example of FIG. 3, the end point B 304 can receive input from the start point A 302, the first fan-in 306A, the second fan-in 306B, and the third fan-in 306C, such that a total number of inputs (e.g., N) to the end point B 304 is 4 (e.g., N=4). Accordingly, the validation control circuitry 200 determines that a number of possible permutations of the input vectors 312 is 2N. In this example, the validation control circuitry 200 selects the input vectors 312 by selecting one(s) of the permutations that satisfy one or more architectural assumptions (e.g., the assumptions 220 of FIG. 2) associated with the diagram 300.

In some examples, in response to the validation control circuitry 200 providing the input vectors 312 to the start point A 302 and the fan-ins 306, a signal transition (e.g., from 0 to 1, from 1 to 0, etc.) can be observed and/or detected at the start point A 302. In some examples, the validation control circuitry 200 injects X at the X injection location 310 for 2 cycles in response to detecting the signal transition at the start point A 302. In some examples, the validation control circuitry 200 monitors the signal at the end point B 304 in response to the signal transition at the start point A 302 and the X injection 310 for 2 cycles. In such examples, the validation control circuitry 200 can determine whether the timing path is correctly defined as a multicycle path of 3 cycles based on whether the X values are observed at the end point B 304.

In the example of FIG. 3, in response to the validation control circuitry 200 not detecting and/or observing the X values at the end point B 304, the validation control circuitry 200 determines that the timing path between the start point A 302 and the end point B 304 is a multicycle path of 3 cycles and, thus, accepts and/or confirms the timing constraint. Alternatively, in response to the validation control circuitry 200 detecting and/or observing X values at the end point B 304, the validation control circuitry 200 determines that the timing path between the start point A 302 and the end point B 304 is not a multicycle path of 3 cycles and, thus, rejects the timing constraint. In some such examples, in response to rejection of the timing constraint, the validation control circuitry 200 determines that the timing constraint is to be adjusted and/or modified. For example, the validation control circuitry 200 can determine that the timing path between the start point A 302 and the end point B 304 is a multicycle path of 2 cycles (e.g., instead of 3 cycles). In some examples, the validation control circuitry 200 automatically adjusts the timing constraint and/or provides an indication to a user to adjust the timing constraint.

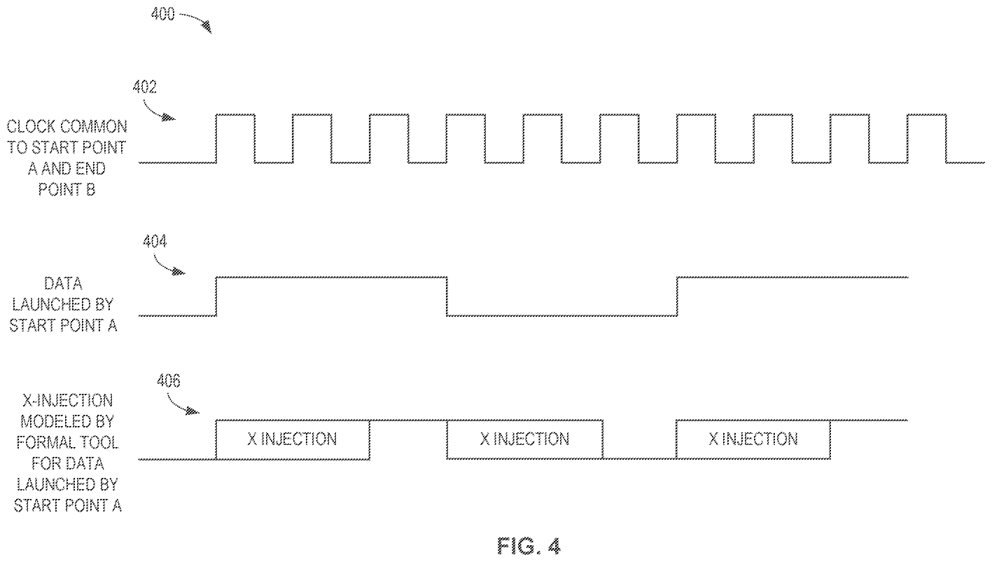

FIG. 4 illustrates example signals (e.g., signal data) 400 observed and/or modelled by the example validation control circuitry 200 for the example diagram 300 of FIG. 3. In the illustrated example of FIG. 4, a first example signal (e.g., a clock signal) 402 represents a clock common to the example start point A 302 and the example end point B 304 of FIG. 3. In this example, a second example signal 404 represents data launched and/or output by the start point A 302 along a timing path from the start point A 302 to the end point B 304. For example, the second signal 404 is launched and/or output responsive to the example input vector(s) 312 of FIG. 3 being provided to the start point A 302 and/or the fan-ins 306 of FIG. 3. Because the timing path is defined as a 3-cycle path, the data launched from the start point A 302 takes 3 clock cycles to reach the end point B 304, where the clock cycles are based on the first signal 402. As such, in the illustrated example, the second signal 404 has a first value (e.g., 1) for 3 clock cycles, and a second value (e.g., 0) for a following 3 clock cycles.

In the example of FIG. 4, the third signal 406 represents the example X injection 310 modeled by the validation control circuitry 200 for the data launched by the start point A 302. In this example, the validation control circuitry 200 injects X along the timing path from the start point A 302 to the end point B 304 for 2 clock cycles. In the example of FIG. 4, the X values are not sampled at end point B 304 when the timing path from the start point A 302 and the end point B 304 is a 3-cycle path. In some examples, when the timing path is not a 3-cycle path (e.g., is a single-cycle or a two-cycle path), the X values are sampled at end point B 304. In some such examples, the validation control circuitry 200 rejects the timing constraint defining a 3-cycle path from the start point A 302 to the end point B 304.

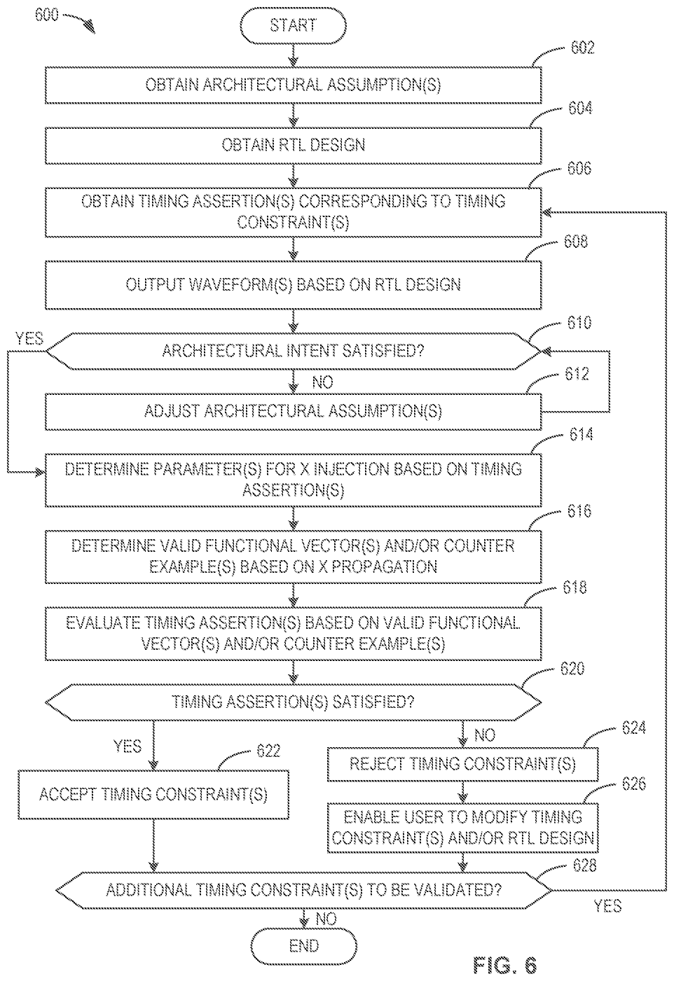

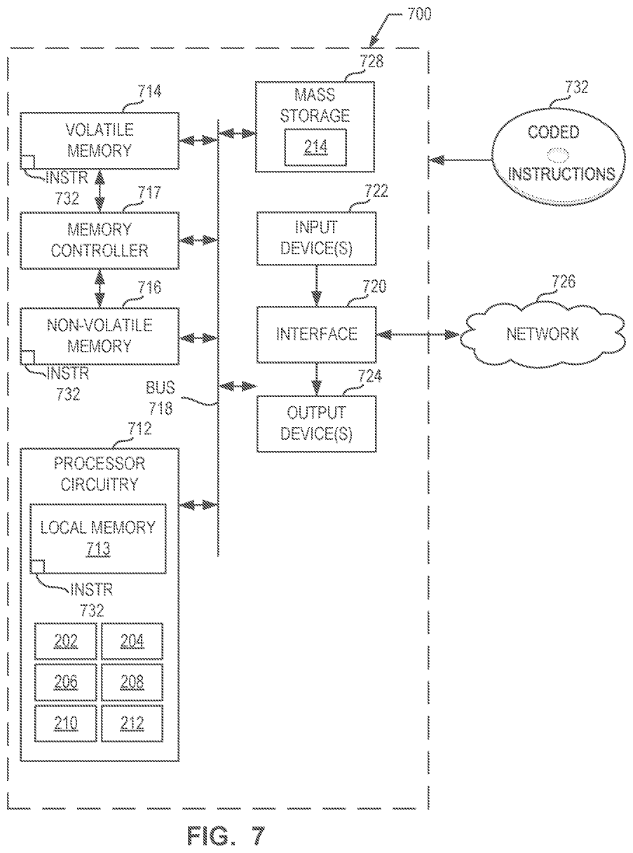

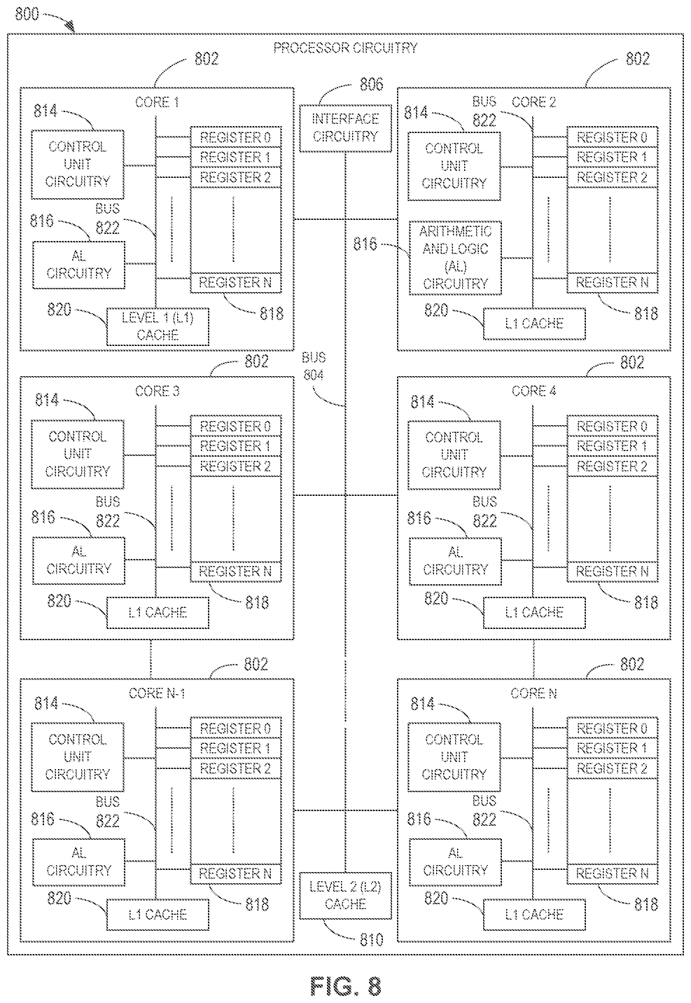

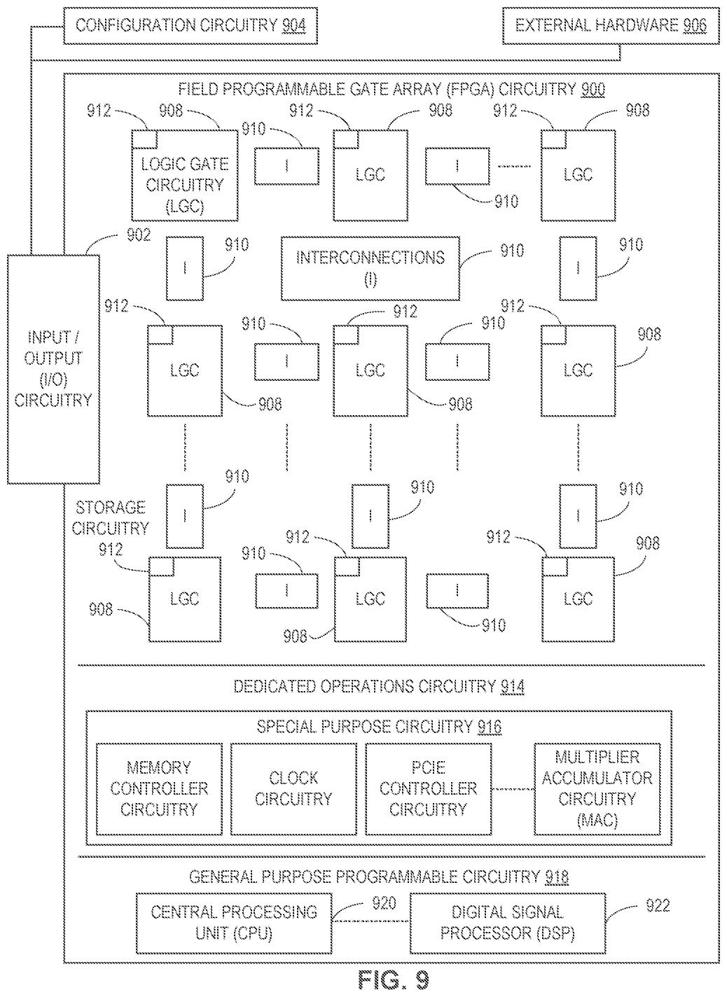

In some examples, the validation control circuitry 200 includes means for obtaining input. For example, the means for obtaining input may be implemented by the input interface circuitry 202. In some examples, the input interface circuitry 202 may be instantiated by programmable circuitry such as the example programmable circuitry 712 of FIG. 7. For instance, the input interface circuitry 202 may be instantiated by the example microprocessor 800 of FIG. 8 executing machine executable instructions such as those implemented by at least blocks 502, 504, 516, 530 of FIG. 5 and/or blocks 602, 604, 612, 628 of FIG. 6. In some examples, the input interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the input interface circuitry 202 may be instantiated by any other combination of hardware, software, and/or firmware. For example, the input interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation control circuitry 200 includes means for outputting. For example, the means for outputting may be implemented by the waveform output circuitry 204. In some examples, the waveform output circuitry 204 may be instantiated by programmable circuitry such as the example programmable circuitry 712 of FIG. 7. For instance, the waveform output circuitry 204 may be instantiated by the example microprocessor 800 of FIG. 8 executing machine executable instructions such as those implemented by at least blocks 512, 514 of FIG. 5 and/or blocks 608, 610 of FIG. 6. In some examples, the waveform output circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the waveform output circuitry 204 may be instantiated by any other combination of hardware, software, and/or firmware. For example, the waveform output circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation control circuitry 200 includes means for generating assertions. For example, the means for generating assertions may be implemented by the assertion generation circuitry 206. In some examples, the assertion generation circuitry 206 may be instantiated by programmable circuitry such as the example programmable circuitry 712 of FIG. 7. For instance, the assertion generation circuitry 206 may be instantiated by the example microprocessor 800 of FIG. 8 executing machine executable instructions such as those implemented by at least blocks 506, 508, 510 of FIG. 5 and/or block 606 of FIG. 6. In some examples, the assertion generation circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the assertion generation circuitry 206 may be instantiated by any other combination of hardware, software, and/or firmware. For example, the assertion generation circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation control circuitry 200 includes means for injecting. For example, the means for injecting may be implemented by the X injection control circuitry 208. In some examples, the X injection control circuitry 208 may be instantiated by programmable circuitry such as the example programmable circuitry 712 of FIG. 7. For instance, the X injection control circuitry 208 may be instantiated by the example microprocessor 800 of FIG. 8 executing machine executable instructions such as those implemented by at least block 614 of FIG. 6. In some examples, the X injection control circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the X injection control circuitry 208 may be instantiated by any other combination of hardware, software, and/or firmware. For example, the X injection control circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation control circuitry 200 includes means for executing formal methods. For example, the means for executing formal methods may be implemented by the formal methods execution circuitry 210. In some examples, the formal methods execution circuitry 210 may be instantiated by programmable circuitry such as the example programmable circuitry 712 of FIG. 7. For instance, the formal methods execution circuitry 210 may be instantiated by the example microprocessor 800 of FIG. 8 executing machine executable instructions such as those implemented by at least block 518 of FIG. 5 and/or block 616 of FIG. 6. In some examples, the formal methods execution circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the formal methods execution circuitry 210 may be instantiated by any other combination of hardware, software, and/or firmware. For example, the formal methods execution circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation control circuitry 200 includes means for validating. For example, the means for validating may be implemented by the constraint validation circuitry 212. In some examples, the constraint validation circuitry 212 may be instantiated by programmable circuitry such as the example programmable circuitry 712 of FIG. 7. For instance, the constraint validation circuitry 212 may be instantiated by the example microprocessor 800 of FIG. 8 executing machine executable instructions such as those implemented by at least blocks 520, 522, 524, 526, 528 of FIG. 5 and/or blocks 618, 620, 622, 624, 626 of FIG. 6. In some examples, the constraint validation circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the constraint validation circuitry 212 may be instantiated by any other combination of hardware, software, and/or firmware. For example, the constraint validation circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the validation control circuitry 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the example input interface circuitry 202, the example waveform output circuitry 204, the example assertion generation circuitry 206, the example X injection control circuitry 208, the example formal methods execution circuitry 210, the example constraint validation circuitry 212, and/or, more generally, the example validation control circuitry 200 of FIG. 2, may be implemented by hardware alone or by hardware in combination with software and/or firmware. Thus, for example, any of the example input interface circuitry 202, the example waveform output circuitry 204, the example assertion generation circuitry 206, the example X injection control circuitry 208, the example formal methods execution circuitry 210, the example constraint validation circuitry 212, and/or, more generally, the example validation control circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example validation control circuitry 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the validation control circuitry 200 of FIG. 2 and/or representative of example operations which may be performed by programmable circuitry to implement and/or instantiate the validation control circuitry 200 of FIG. 2, are shown in FIGS. 5 and/or 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and/or 6, many other methods of implementing the example validation control circuitry 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and/or 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to verify example timing constraints. The example machine-readable instructions and/or the example operations 500 of FIG. 5 begin at block 502, at which the example validation control circuitry 200 of FIG. 2 obtains one or more architectural assumptions (e.g., the assumptions 220 of FIG. 2) associated with an example SoC design. For example, the example input interface circuitry 202 of FIG. 2 obtains the assumptions 220 based on input by a designer to an example FPV tool. In some examples, the assumptions 220 correspond to architectural properties of the SoC including initial states of one or more elements of the SoC design, states that need not be checked, etc.

At block 504, the example validation control circuitry 200 obtains the example RTL design 222 of FIG. 2. For example, the input interface circuitry 202 obtains the RTL design 222 representing flows of signals between hardware registers of the SoC and one or more logical operations performed on the signals. In some examples, the RTL design 222 is expressed using HDL, such as VHDL or Verilog. In some examples, the RTL design 222 is previously generated for the SoC and the designer inputs and/or ports the RTL design 222 to the FPV tool.

At block 506, the example validation control circuitry 200 obtains the one or more example timing constraints 224 of FIG. 2. For example, the example assertion generation circuitry 206 of FIG. 2 obtains the timing constraints 224 provided as input by the designer into the FPV tool. In some examples, the timing constraints 224 define one or more example timing requirements for one or more elements of the RTL design 222. For example, the timing constraints 224 can include one or more of multicycle paths, false paths, cross clock global asynchronous paths, clock characteristics, etc.

At block 508, the example validation control circuitry 200 determines whether the timing constraints 224 are provided as timing assertions. For example, the assertion generation circuitry 206 determines whether the timing constraints 224 were manually converted to timing assertions prior to input to the FPV tool. In response to the assertion generation circuitry 206 determining that the timing constraints 224 were provided as timing assertions (e.g., block 508 returns a result of YES), control proceeds to block 512. Alternatively, in response to the assertion generation circuitry 206 determining that the timing constraints 224 were not provided as timing assertions (e.g., block 508 returns a result of NO), control proceeds to block 510.

At block 510, the example validation control circuitry 200 converts the example timing constraints 224 to corresponding example timing assertions. For example, the assertion generation circuitry 206 determines one or more example timing assertions based on the timing constraints 224 based on execution of an example script provided to the FPV tool. In one example, for one of the timing constraints 224 defining an N-cycle path between a start point A and an end point B, the assertion generation circuitry 206 determines that the corresponding timing assertion is that data sampled at end point B should not change within N clock cycles.

At block 512, the example validation control circuitry 200 outputs one or more example waveforms based on the RTL design 222. For example, the example waveform output circuitry 204 simulates the RTL design 222 with the architectural assumptions 220 to output the one or more example waveforms indicative of functional behavior of the RTL design 222. In some examples, the waveforms can indicate whether data is being written to and/or read from one or more elements of the RTL design 222.

At block 514, the example validation control circuitry 200 determines whether architectural intent for the RTL design 222 is satisfied. For example, a designer inspects the waveform(s) output by the waveform output circuitry 204 to determine whether the architectural intent of the designer is satisfied. In some examples, the architectural intent is not satisfied as a result of one or more of the assumptions 220 being incorrectly ported and/or written to the FPV tool. For example, the designer may write the assumptions 220 with the intent of preventing reading of data from an empty FIFO of the RTL design 222. However, due to improper porting of the assumptions 220, the FPV tool may attempt to read data from the empty FIFO during simulation of the RTL design 222. In some examples, the waveform output circuitry 204 determines whether the architectural intent is satisfied based on user input by the designer to the FPV tool. In some examples, in response to the waveform output circuitry 204 determining that the architectural intent is satisfied (e.g., block 514 returns a result of YES), control proceeds to block 518. Alternatively, in response to the waveform output circuitry 204 determining that the architectural intent is not satisfied (e.g., block 514 returns a result of NO), control proceeds to block 516.

At block 516, the example validation control circuitry 200 adjusts one or more of the architectural assumptions 220. For example, the input interface circuitry 202 adjusts the one or more of the architectural assumptions 220 based on the designer providing new and/or revised architectural assumptions to the FPV tool. In some examples, the designer continues to adjust the architectural assumptions 220 based on the resulting waveforms output by the waveform output circuitry 204 until the architectural intent is satisfied.

At block 518, the example validation control circuitry 200 determines the example valid functional vectors 226 and/or the example counter examples 228 of FIG. 2. For example, the example formal methods execution circuitry 210 of FIG. 2 determines the valid functional vectors 226 and/or the counter examples 228 by determining all possible test cases (e.g., all the possible input vectors 312 of FIG. 3) that satisfy the architectural assumptions 220. In some examples, the formal methods execution circuitry 210 identifies first one(s) of the input vectors 312 that satisfy both the architectural assumptions 220 and the timing assertions as the valid functional vectors 226, and identifies second one(s) of the input vectors 312 that satisfy the architectural assumptions 220 but fail the timing assertions as the counter examples 228.

At block 520, the example validation control circuitry 200 evaluates one or more of the example timing assertions based on the valid functional vectors 226 and/or the counter examples 228. For example, the example constraint validation circuitry 212 of FIG. 2 evaluates one(s) of the counter examples 228 on the RTL design 222, and determines whether one(s) of the timing assertions fail for the one(s) of the counter examples 228. In some examples, the constraint validation circuitry 212 evaluates signals at one or more elements (e.g., hardware registers) of the RTL design 222 responsive to the counter examples 228 being applied on the RTL design 222. In such examples, the constraint validation circuitry 212 compares the evaluated signals at the element(s) to expected signals based on the timing assertions.

At block 522, the example validation control circuitry 200 determines whether one or more of the timing assertions are satisfied. For example, the constraint validation circuitry 212 determines whether one or more of the timing assertions fail (e.g., are not satisfied) in response to one(s) of the counter examples 228 being evaluated on the RTL design 222. In response to the constraint validation circuitry 212 determining that the one or more timing assertions are satisfied (e.g., block 522 returns a result of YES), control proceeds to block 524. Alternatively, in response to the constraint validation circuitry 212 determining that one or more of the timing assertions are not satisfied (e.g., block 522 returns a result of NO), control proceeds to block 526.

At block 524, the example validation control circuitry 200 accepts (e.g., validates and/or verifies) one or more of the timing constraints 224. For example, the constraint validation circuitry 212 accepts first one(s) of the timing constraints 224 corresponding to first one(s) of the timing assertions that are satisfied when ones of the valid functional vectors 226 and/or the counter examples 228 are simulated on the RTL design 222. In some examples, the constraint validation circuitry 212 accepts the first one(s) of the timing constraints 224 when none of the counter examples 228 fail the corresponding timing assertions.

At block 526, the example validation control circuitry 200 rejects one or more of the timing constraints 224. For example, the constraint validation circuitry 212 identifies second one(s) of the timing constraints 224 corresponding to second one(s) of the timing assertions that fail when ones of the counter examples 228 are simulated on the RTL design 222, and the constraint validation circuitry 212 rejects the second one(s) of the timing constraints 224. In some examples, the constraint validation circuitry 212 rejects the second one(s) of the timing constraints 224 when at least one of the counter examples 228 fails the corresponding timing assertions.

At block 528, the example validation control circuitry 200 enables a user to modify (e.g., adjust) one(s) of the timing constraints 224 and/or the RTL design 222. For example, the constraint validation circuitry 212 generates and/or presents an indication to the user to indicate the one(s) of the timing constraints 224 that were rejected. In some examples, the user can modify and/or adjust the one(s) of the timing constraints 224 and/or one or more components of the RTL design 222. In some examples, the indication generated by the constraint validation circuitry 212 includes a recommendation for modifying the one(s) of the timing constraints 224. In one example, when the counter examples 228 fail one of the timing constraints 224 defining a 3-cycle path between a start point A and an end point B, the indication includes a recommendation to adjust the one of the timing constraints 224 to define a 2-cycle path between the start point A and the end point B.

At block 530, the example validation control circuitry 200 determines whether there are additional one(s) of the timing constraints 224 to be validated. For example, the example input interface circuitry 202 determines whether additional timing constraints are obtained by and/or provided to the FPV tool. In response to the input interface circuitry 202 determining that there are additional timing constraints 224 to be validated (e.g., block 530 returns a result of YES), control returns to block 506. Alternatively, in response to the input interface circuitry 202 determining that there are no additional timing constraints 224 to be validated (e.g., block 530 returns a result of NO), control ends.

FIG. 6 is a flowchart representative of example machine readable instructions and/or example operations 600 that may be executed, instantiated, and/or performed by programmable circuitry to verify example timing constraints based on X propagation. The example machine-readable instructions and/or the example operations 600 of FIG. 6 begin at block 602, at which the example validation control circuitry 200 of FIG. 2 obtains one or more architectural assumptions (e.g., the assumptions 220 of FIG. 2) associated with an example SoC design. For example, the example input interface circuitry 202 of FIG. 2 obtains the assumptions 220 based on input by a designer to an example FPV tool. In some examples, the assumptions 220 correspond to architectural properties of the SoC including initial states of one or more elements of the SoC design, states that need not be checked, etc.

At block 604, the example validation control circuitry 200 obtains the example RTL design 222 of FIG. 2. For example, the input interface circuitry 202 obtains the RTL design 222 representing flows of signals between hardware registers of the SoC and one or more logical operations performed on the signals. In some examples, the RTL design 222 is expressed using HDL, such as VHDL or Verilog. In some examples, the RTL design 222 is previously generated for the SoC and the designer inputs and/or ports the RTL design 222 to the FPV tool.

At block 606, the example validation control circuitry 200 obtains and/or determines one or more timing assertions corresponding to the one or more example timing constraints 224 of FIG. 2. For example, the example assertion generation circuitry 206 of FIG. 2 obtains the timing constraints 224 provided as input by the designer into the FPV tool, and converts the timing constraints 224 to the corresponding timing assertions. Additionally or alternatively, the timing constraints 224 are manually converted by the designer into the corresponding timing assertions, and the assertion generation circuitry 206 obtains the timing assertions based on the designer inputting the timing assertions into the FPV tool.

At block 608, the example validation control circuitry 200 outputs one or more example waveforms based on the RTL design 222. For example, the example waveform output circuitry 204 simulates the RTL design 222 with the architectural assumptions 220 to output the one or more example waveforms indicative of functional behavior of the RTL design 222.

At block 610, the example validation control circuitry 200 determines whether architectural intent for the RTL design 222 is satisfied. For example, a designer inspects the waveform(s) output by the waveform output circuitry 204 to determine whether the architectural intent of the designer is satisfied. In some examples, the architectural intent is not satisfied as a result of one or more of the assumptions 220 being incorrectly ported and/or written to the FPV tool. In some examples, in response to the waveform output circuitry 204 determining that the architectural intent is satisfied (e.g., block 610 returns a result of YES), control proceeds to block 614. Alternatively, in response to the waveform output circuitry 204 determining that the architectural intent is not satisfied (e.g., block 610 returns a result of NO), control proceeds to block 612.

At block 612, the example validation control circuitry 200 adjusts one or more of the architectural assumptions 220. For example, the input interface circuitry 202 adjusts the one or more of the architectural assumptions 220 based on the designer providing new and/or revised architectural assumptions to the FPV tool. In some examples, the designer continues to adjust the architectural assumptions 220 based on the resulting waveforms output by the waveform output circuitry 204 until the architectural intent is satisfied.

At block 614, the example validation control circuitry 200 determines, based on the timing assertions, one or more example parameters (e.g., location(s), frequency, etc.) for the example X injection 310 of FIG. 3. In some examples, the example X injection control circuitry 208 of FIG. 2 determines one or more locations of the RTL design 222 at which X values are to be injected and/or provided. For example, the X injection control circuitry 208 determines the location(s) based on the element(s) and/or the timing paths for which the timing constraints 224 and/or the corresponding timing assertions are applied. In one example, when the timing constraints 224 define an N-cycle path from the example start point A 302 to the example end point B 304 of FIG. 3, the X injection control circuitry 208 determines that X values are to be provided along the timing path between the start point A 302 to the example end point B 304 to validate and/or verify the timing constraints 224. In some examples, the X injection control circuitry 208 determines, based on the timing assertions, frequencies and/or durations for which the X values are to be injected. For example, for the N-cycle path from the example start point A 302 to the example end point B 304, the X injection control circuitry 208 determines that the X values are to be injected for N−1 cycles. In some examples, the X injection control circuitry 208 generates and/or provides X injection instrumentation code to the FPV tool to control the location(s), the frequency, and/or the duration for the X injection 310.

At block 616, the example validation control circuitry 200 determines the example valid functional vectors 226 and/or the example counter examples 228 of FIG. 2 based on propagation of the X values. For example, the example formal methods execution circuitry 210 of FIG. 2 determines the valid functional vectors 226 and/or the counter examples 228 by determining all possible test cases (e.g., all the possible input vectors 312 of FIG. 3) that satisfy the architectural assumptions 220. In some examples, the formal methods execution circuitry 210 identifies first one(s) of the input vectors 312 that satisfy both the architectural assumptions 220 and the timing assertions as the valid functional vectors 226, and identifies second one(s) of the input vectors 312 that satisfy the architectural assumptions 220 but fail the timing assertions as the counter examples 228. In some examples, the formal methods execution circuitry 210 determines whether one(s) of the input vectors 312 fail the timing assertions based on whether X values are sampled at one or more elements of the RTL design 222 when the one(s) of the input vectors 312 are evaluated on the RTL design 222.

At block 618, the example validation control circuitry 200 evaluates one or more of the example timing assertions based on the valid functional vectors 226 and/or the counter examples 228. For example, the example constraint validation circuitry 212 of FIG. 2 evaluates one(s) of the counter examples 228 on the RTL design 222, and determines whether one(s) of the timing assertions fail for the one(s) of the counter examples 228. In some examples, the constraint validation circuitry 212 evaluates signals at one or more elements (e.g., hardware registers) of the RTL design 222 responsive to the counter examples 228 being applied on the RTL design 222. In such examples, the constraint validation circuitry 212 compares the evaluated signals at the element(s) to expected signals based on the timing assertions.

At block 620, the example validation control circuitry 200 determines whether one or more of the timing assertions are satisfied. For example, the constraint validation circuitry 212 determines that the one or more timing assertions fail when X values are sampled by one or more elements of the RTL design 222. For example, when a N-cycle path is defined for a timing path from the start point A 302 to the end point B 304 and X is injected for N−1 cycles, the constraint validation circuitry 212 determines that the timing assertion fails for the timing path when the X is sampled at the end point B 304. In response to the constraint validation circuitry 212 determining that the one or more timing assertions are satisfied (e.g., block 620 returns a result of YES), control proceeds to block 622. Alternatively, in response to the constraint validation circuitry 212 determining that one or more of the timing assertions are not satisfied (e.g., block 620 returns a result of NO), control proceeds to block 624.

At block 622, the example validation control circuitry 200 accepts (e.g., validates and/or verifies) one or more of the timing constraints 224. For example, the constraint validation circuitry 212 accepts first one(s) of the timing constraints 224 corresponding to first one(s) of the timing assertions that are satisfied when ones of the valid functional vectors 226 and/or the counter examples 228 are simulated on the RTL design 222. In some examples, the constraint validation circuitry 212 accepts the first one(s) of the timing constraints 224 when there are no counter examples 228 that fail the corresponding timing assertions.

At block 624, the example validation control circuitry 200 rejects one or more of the timing constraints 224. For example, the constraint validation circuitry 212 rejects second one(s) of the timing constraints 224 corresponding to second one(s) of the timing assertions that fail when one or more of the counter examples 228 are simulated on the RTL design 222. In some examples, the constraint validation circuitry 212 rejects the second one(s) of the timing constraints 224 when at least one of the counter examples 228 fails the corresponding timing assertions.

At block 626, the example validation control circuitry 200 enables a user to modify (e.g., adjust) one(s) of the timing constraints 224 and/or the RTL design 222. For example, the constraint validation circuitry 212 generates and/or presents an indication to the user to indicate the one(s) of the timing constraints 224 that were rejected. In some examples, the user can modify the one(s) of the timing constraints 224 and/or one or more elements of the RTL design 222. In some examples, the indication generated by the constraint validation circuitry 212 includes a recommendation for modifying the one(s) of the timing constraints 224.

At block 628, the example validation control circuitry 200 determines whether there are additional one(s) of the timing constraints 224 to be validated. For example, the example input interface circuitry 202 determines whether additional timing constraints are obtained by and/or provided to the FPV tool. In response to the input interface circuitry 202 determining that there are additional timing constraints 224 to be validated (e.g., block 628 returns a result of YES), control returns to block 606. Alternatively, in response to the input interface circuitry 202 determining that there are no additional timing constraints 224 to be validated (e.g., block 628 returns a result of NO), control ends.

FIG. 7 is a block diagram of an example programmable circuitry platform 700 structured to execute and/or instantiate the example machine-readable instructions and/or the example operations of FIGS. 5 and/or 6 to implement the validation control circuitry 200 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example input interface circuitry 202, the example waveform output circuitry 204, the example assertion generation circuitry 206, the example X injection control circuitry 208, the example formal methods execution circuitry 210, and the example constraint validation circuitry 212.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and/or 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and/or 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and/or 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and/or 6. As such, the FPGA circuitry 900 may be configured and/or structured to effectively instantiate some or all of the operations/functions corresponding to the machine readable instructions of the flowchart(s) of FIGS. 5 and/or 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and/or 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and/or 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and/or 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and/or 6, and/or an ASIC may be configured and/or structured to perform third operation(s)/function(s) corresponding to a third portion of the machine readable instructions represented by the flowcharts of FIGS. 5 and/or 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

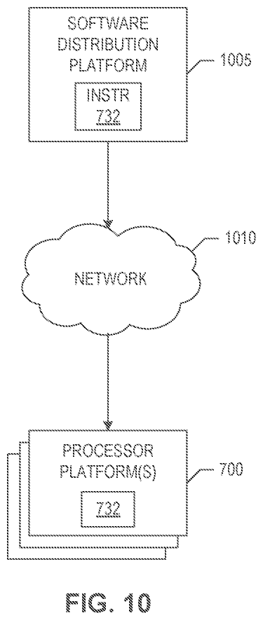

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and/or 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and/or 6, may be downloaded to the example programmable circuitry platform 700, which is to execute the machine readable instructions 732 to implement the validation control circuitry 200. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that validate timing constraints for an integrated circuit (IC) package. Examples disclosed herein enable example timing constraints to be validated and/or verified by an example FPV tool, where the timing constraints can be directly input to the FPV tool and/or converted to corresponding timing assertions prior to input to the FPV tool. In examples disclosed herein, one or more valid functional vectors and/or counter examples are determined based on the timing assertions and/or example architectural assumptions provided to the FPV tool, such that test vectors that do not satisfy the architectural assumptions are automatically omitted and/or not used for validation of the timing constraints. Accordingly, examples disclosed herein enable selection of test vectors with less manual intervention compared to known static and/or dynamic verification methods, thus reducing likelihood of incorrect selection of test vectors due to human error. Further, disclosed systems, apparatus, articles of manufacture, and methods improve the efficiency of using a computing device by reducing a number of test vectors to be simulated and/or tested on an example RTL design. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to validate timing constraints for an integrated circuit are disclosed herein. Further examples and combinations thereof include the following:

Example 1 includes an apparatus comprising interface circuitry, machine readable instructions, and programmable circuitry to at least one of instantiate or execute the machine readable instructions to obtain an assumption property associated with a system on a chip (SoC) architecture, obtain a timing assertion associated with the SoC architecture, determine, using a formal property verification (FPV) tool, valid functional vectors and counter examples for the SoC architecture based on the assumption property and the timing assertion, and determine whether to accept a timing constraint based on at least one of the valid functional vectors or the counter examples, the timing constraint corresponding to the timing assertion.

Example 2 includes the apparatus of example 1, wherein the programmable circuitry is to obtain the timing assertion based on user input to the FPV tool.

Example 3 includes the apparatus of example 1, wherein the programmable circuitry is to obtain the timing constraint based on user input to the FPV tool, and convert the timing constraint into the timing assertion.

Example 4 includes the apparatus of example 1, wherein the timing constraint corresponds to at least one of a multi cycle path, a false path, a maximum delay path, a minimum delay path, or a reconverge cross clock path.

Example 5 includes the apparatus of example 1, wherein the programmable circuitry is to select, based on the timing assertion, at least one of a location or a duration for X injection in a register-transfer level (RTL) design, the RTL design corresponding to the SoC architecture.

Example 6 includes the apparatus of example 5, wherein the programmable circuitry is to identify a timing path associated with the timing assertion, the timing path from a start point to an end point based on the RTL design, and select the location for the X injection corresponding to the timing path.

Example 7 includes the apparatus of example 6, wherein the programmable circuitry is to simulate an input vector on the RTL design to stress the timing path, evaluate a signal at the end point responsive to the input vector, based on the evaluation, determine whether the timing assertion is satisfied, based on the timing assertion being satisfied, assign the input vector as one of the valid functional vectors, and based on the timing assertion not being satisfied, assign the input vector as one of the counter examples.

Example 8 includes the apparatus of example 1, wherein the programmable circuitry is to output the valid functional vectors and the counter examples without outputting vectors that do not satisfy the assumption property.

Example 9 includes a non-transitory computer readable medium comprising instructions that, when executed, cause programmable circuitry to obtain an assumption property associated with a system on a chip (SoC) architecture, obtain a timing assertion associated with the SoC architecture, determine, using a formal property verification (FPV) tool, valid functional vectors and counter examples for the SoC architecture based on the assumption property and the timing assertion, and determine whether to accept a timing constraint based on at least one of the valid functional vectors or the counter examples, the timing constraint corresponding to the timing assertion.

Example 10 includes the non-transitory computer readable medium of example 9, wherein the instructions cause the programmable circuitry to obtain the timing assertion based on user input to the FPV tool.

Example 11 includes the non-transitory computer readable medium of example 9, wherein the instructions cause the programmable circuitry to obtain the timing constraint based on user input to the FPV tool, and convert the timing constraint into the timing assertion.

Example 12 includes the non-transitory computer readable medium of example 9, wherein the instructions cause the programmable circuitry to select, based on the timing assertion, at least one of a location or a duration for X injection in a register-transfer level (RTL) design, the RTL design corresponding to the SoC architecture.

Example 13 includes the non-transitory computer readable medium of example 12, wherein the instructions cause the programmable circuitry to identify a timing path associated with the timing assertion, the timing path from a start point to an end point based on the RTL design, and select the location for the X injection corresponding to the timing path.

Example 14 includes the non-transitory computer readable medium of example 13, wherein the instructions cause the programmable circuitry to simulate an input vector on the RTL design to stress the timing path, evaluate a signal at the end point responsive to the input vector, based on the evaluation, determine whether the timing assertion is satisfied, based on the timing assertion being satisfied, assign the input vector as one of the valid functional vectors, and based on the timing assertion not being satisfied, assign the input vector as one of the counter examples.

Example 15 includes the non-transitory computer readable medium of example 9, wherein the instructions cause the programmable circuitry to output the valid functional vectors and the counter examples without outputting vectors that do not satisfy the assumption property.

Example 16 includes a method comprising obtaining an assumption property associated with a system on a chip (SoC) architecture, obtaining a timing assertion associated with the SoC architecture, determining, using a formal property verification (FPV) tool, valid functional vectors and counter examples for the SoC architecture based on the assumption property and the timing assertion, and determining whether to accept a timing constraint based on at least one of the valid functional vectors or the counter examples, the timing constraint corresponding to the timing assertion.

Example 17 includes the method of example 16, further including selecting, based on the timing assertion, at least one of a location or a duration for X injection in a register-transfer level (RTL) design, the RTL design corresponding to the SoC architecture.

Example 18 includes the method of example 17, further including identifying a timing path associated with the timing assertion, the timing path from a start point to an end point based on the RTL design, and selecting the location for the X injection corresponding to the timing path.

Example 19 includes the method of example 18, further including simulating an input vector on the RTL design to stress the timing path, evaluating a signal at the end point responsive to the input vector, based on the evaluation, determining whether the timing assertion is satisfied, based on the timing assertion being satisfied, assigning the input vector as one of the valid functional vectors, and based on the timing assertion not being satisfied, assigning the input vector as one of the counter examples.

Example 20 includes the method of example 16, further including outputting the valid functional vectors and the counter examples without outputting vectors that do not satisfy the assumption property.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
obtain an assumption property associated with a system on a chip (SoC) architecture;
obtain a timing assertion associated with the SoC architecture;
determine, using a formal property verification (FPV) tool, valid functional vectors and counter examples for the SoC architecture based on the assumption property and the timing assertion; and
determine whether to accept a timing constraint based on at least one of the valid functional vectors or the counter examples, the timing constraint corresponding to the timing assertion.

2. The apparatus of claim 1, wherein the programmable circuitry is to obtain the timing assertion based on user input to the FPV tool.

3. The apparatus of claim 1, wherein the programmable circuitry is to:
obtain the timing constraint based on user input to the FPV tool; and
convert the timing constraint into the timing assertion.

4. The apparatus of claim 1, wherein the timing constraint corresponds to at least one of a multi cycle path, a false path, a maximum delay path, a minimum delay path, or a reconverge cross clock path.

5. The apparatus of claim 1, wherein the programmable circuitry is to select, based on the timing assertion, at least one of a location or a duration for X injection in a register-transfer level (RTL) design, the RTL design corresponding to the SoC architecture.

6. The apparatus of claim 5, wherein the programmable circuitry is to:
identify a timing path associated with the timing assertion, the timing path from a start point to an end point based on the RTL design; and
select the location for the X injection corresponding to the timing path.

7. The apparatus of claim 6, wherein the programmable circuitry is to:
simulate an input vector on the RTL design to stress the timing path;
evaluate a signal at the end point responsive to the input vector;
based on the evaluation, determine whether the timing assertion is satisfied;
based on the timing assertion being satisfied, assign the input vector as one of the valid functional vectors; and
based on the timing assertion not being satisfied, assign the input vector as one of the counter examples.

8. The apparatus of claim 1, wherein the programmable circuitry is to output the valid functional vectors and the counter examples without outputting vectors that do not satisfy the assumption property.

9. A non-transitory computer readable medium comprising instructions that, when executed, cause programmable circuitry to:
obtain an assumption property associated with a system on a chip (SoC) architecture;
obtain a timing assertion associated with the SoC architecture;
determine, using a formal property verification (FPV) tool, valid functional vectors and counter examples for the SoC architecture based on the assumption property and the timing assertion; and
determine whether to accept a timing constraint based on at least one of the valid functional vectors or the counter examples, the timing constraint corresponding to the timing assertion.

10. The non-transitory computer readable medium of claim 9, wherein the instructions cause the programmable circuitry to obtain the timing assertion based on user input to the FPV tool.

11. The non-transitory computer readable medium of claim 9, wherein the instructions cause the programmable circuitry to:
obtain the timing constraint based on user input to the FPV tool; and
convert the timing constraint into the timing assertion.

12. The non-transitory computer readable medium of claim 9, wherein the instructions cause the programmable circuitry to select, based on the timing assertion, at least one of a location or a duration for X injection in a register-transfer level (RTL) design, the RTL design corresponding to the SoC architecture.

13. The non-transitory computer readable medium of claim 12, wherein the instructions cause the programmable circuitry to:
identify a timing path associated with the timing assertion, the timing path from a start point to an end point based on the RTL design; and
select the location for the X injection corresponding to the timing path.

14. The non-transitory computer readable medium of claim 13, wherein the instructions cause the programmable circuitry to:
simulate an input vector on the RTL design to stress the timing path;
evaluate a signal at the end point responsive to the input vector;
based on the evaluation, determine whether the timing assertion is satisfied;
based on the timing assertion being satisfied, assign the input vector as one of the valid functional vectors; and
based on the timing assertion not being satisfied, assign the input vector as one of the counter examples.

15. The non-transitory computer readable medium of claim 9, wherein the instructions cause the programmable circuitry to output the valid functional vectors and the counter examples without outputting vectors that do not satisfy the assumption property.

16. A method comprising:
obtaining an assumption property associated with a system on a chip (SoC) architecture;
obtaining a timing assertion associated with the SoC architecture;
determining, using a formal property verification (FPV) tool, valid functional vectors and counter examples for the SoC architecture based on the assumption property and the timing assertion; and
determining whether to accept a timing constraint based on at least one of the valid functional vectors or the counter examples, the timing constraint corresponding to the timing assertion.

17. The method of claim 16, further including selecting, based on the timing assertion, at least one of a location or a duration for X injection in a register-transfer level (RTL) design, the RTL design corresponding to the SoC architecture.

18. The method of claim 17, further including:
identifying a timing path associated with the timing assertion, the timing path from a start point to an end point based on the RTL design; and
selecting the location for the X injection corresponding to the timing path.

19. The method of claim 18, further including:
simulating an input vector on the RTL design to stress the timing path;
evaluating a signal at the end point responsive to the input vector;
based on the evaluation, determining whether the timing assertion is satisfied;
based on the timing assertion being satisfied, assigning the input vector as one of the valid functional vectors; and
based on the timing assertion not being satisfied, assigning the input vector as one of the counter examples.

20. The method of claim 16, further including outputting the valid functional vectors and the counter examples without outputting vectors that do not satisfy the assumption property.
